(19) United States
(12) Patent Application Publication
(10) Pub. No.: US 2016/0051079 A1
(43) Pub. Date: Feb. 25, 2016

(54) Capsule-Based Beverage Production System With Inductive Liquid Heating

(71) Applicant: NESTEC S.A., Vevey (CH)

(72) Inventors: Daniel Abegglen, CH (CH); Carlo MAGRI, Collombey (CH); Alexandre KOLLEP, Lutry (CH); Etienne CLOSSET, Corcelles-Cormondrèche (CH); Fausto DI MUZIO, Pully (CH)

(21) Appl. No.: 14/779,059

(22) PCT Filed: Mar. 24, 2014
(86) PCT No.: PCT/EP2014/055786

§ 371 Date: Sep. 22, 2015

(30) Foreign Application Priority Data
Mar. 22, 2013 (EP) 13160594.1

(51) Int. Cl. A47J 31/40; A47J 31/46

(52) U.S. Cl. CPC A47J 31/407; A47J 31/46

(57) ABSTRACT

A beverage production system is disclosed that includes a capsule and a beverage production machine designed for producing a beverage from ingredient(s) in the capsule. At least a portion of the outer surface of the capsule includes at least one metallic and/or electrically conductive area, and the beverage production machine includes means for generating and for contactlessly coupling electrical heating power to the metallic and/or electrically conductive area of the capsule.

### CROSS REFERENCE TO RELATED APPLICATIONS/Incorporation By Reference Statement

This application is a US national stage application filed under 35 USC §371 of International Application No. PCT/EP2014/055786, filed Mar. 24, 2014; which claims benefit of EP Application No. 13160594.1, filed Mar. 22, 2013. The entire contents of the above-referenced applications are hereby expressly incorporated herein by reference.

### BACKGROUND

The presently disclosed and/or claimed inventive concept(s) generally relates to a beverage production system and a method for producing a beverage using an inductive heating.

WO 2011/138368 A1 relates to a brewing or preparation chamber for a beverage-making machine. In particular, a capsule to be inserted into a brewing chamber has a conductive outer surface, wherein this surface is electrically connected by pins to the brewing chamber. In this way, the wall of the capsule can be heated by providing a power generator which is connected to the pins of the brewing chamber.

However, heating of the capsule wall by providing pins is quite accident-sensitive, since the pins penetrate the outer wall of the capsule. Furthermore, there is a need to heat the fluid before entering the interior of the capsule to better control the heating operation. Finally, according to this prior art approach there is no galvanic isolation barrier between the machine and the capsule.

Therefore, the presently disclosed and/or claimed inventive concept(s) provides an improved beverage production system and an improved method for producing a beverage.

### BRIEF DESCRIPTION OF THE DRAWINGS

FIG. 1 shows an extraction system known from EP 512470 A1.

FIG. 2 shows a first embodiment of the beverage production system according to the presently disclosed and/or claimed inventive concept(s).

FIG. 3 shows a second embodiment of the beverage production system according to the presently disclosed and/or claimed inventive concept(s).

FIG. 4 shows a third embodiment of the beverage production system according to the presently disclosed and/or claimed inventive concept(s).

### DETAILED DESCRIPTION

According to a first aspect of the presently disclosed and/or claimed inventive concept(s), a beverage production system comprises a capsule designed for containing at least one beverage ingredient, a beverage production machine designed for producing a beverage from the capsules' ingredients by having a liquid under pressure enter the capsule in order to interact with ingredients in the capsule, wherein the beverage production machine comprises a bell-shaped enclosing member for enclosing the capsule. At least a portion of the outer surface of a wall of the capsule comprises at least one metallic or/and electrically conductive area and the beverage production machine comprises means for generating and for contactlessly coupling electrical heating power to the metallic or/and electrically conductive areas of the capsule.

This particularly enables for heating the metallic or/and electrically conductive areas of the capsule by induction and a contactless heating of the capsule body and wall can be reached. Furthermore, an enhanced user comfort can be provided due to an instant heating of the liquid under pressure before the liquid under pressure enters the interior of the capsule. The combination of the above mentioned features also results in lesser machine breakdowns due to a possible reduced scaling of the beverage production system, since no separate boiler is needed anymore and the heating can be performed within the enclosing member. Furthermore, also a lower energy consumption can be reached in comparison to a boiling of the liquid under pressure before entering the beverage production machine, since not the whole capacity of the boiler has to be heated before entering the interior of the capsule, but only the amount of liquid which is to enter the interior of the capsule for producing a certain amount of beverage.

Furthermore, a generator unit generating power supplied to means for contactlessly coupling electrical heating power to the metallic or/and electrically conductive area of the capsule can be provided.

The means for contactlessly coupling electrical heating power can comprise induction coils.

In addition, the metallic or/and electrically conductive areas at least partially can consist of metal such as e.g. aluminum or any other electrically conductive material (e.g. graphite, loaded polymers, conductive polymers)

According to another aspect of the presently disclosed and/or claimed inventive concept(s) the beverage production system can comprise a capsule designed for containing at least one beverage ingredient and a beverage production machine designed for producing a beverage from the capsule's ingredients by having a liquid under pressure enter the capsule in order to interact with the ingredients in the capsule, wherein the beverage production machine comprises a bell shaped enclosing member for enclosing the capsule, wherein the beverage production machine is designed to have liquid under pressure enter a gap arranged in the rim area of bell-shaped enclosing member, such that the liquid under pressure enters a space between the outer surface of the capsule wall and an inner wall of enclosing member in order to enter the interior of capsule through at least one inlet opening in the wall of the capsule, which opening maybe pre-produced or produced by at least one opening means of beverage production machine.

Further, at least one temperature probe can be provided at the inner wall of the enclosing member to measure the temperature in the space between outer surface of the capsule wall and inner wall of the enclosing member.

Ridges can be provided at the inner wall of the enclosing member projecting into the space between outer surface of the capsule wall and the inner wall of the enclosing member for creating a turbulent flow and or a prolonged flow (meandering) of the fluid.

In addition, liquid under pressure can be supplied to the beverage production machine from a liquid tank.

Further, at least one pump unit can pump the liquid under pressure to the beverage production machine.

At least one flow meter can be provided between the liquid tank and the beverage production machine for measuring the flow per time unit.

None or one or more pre-heating units of the machine can pre-heat the liquid under pressure (liquid not necessarily under pressure for heating) before being supplied to the capsule. Pre-heating serves for supporting the overall heating operation, so that the means for contactlessly coupling electrical heating power only has to further heat the liquid under pressure from the pre-heated temperature to the final temperature at which the liquid under pressure enters the interior of the capsule.

The preheating can be performed, but is not limited to several technologies. In particular, conventional boilers can be used for preheating. Further, also an induction heating of a liquid supply pipe supplying liquid from the liquid tank to the beverage production machine can be performed. In addition, heating of a metallic capsule holder or of a metallic part inside the capsule holder is also conceivable for a preheating. Preheating can also be performed by a heat recuperation from the induction coils. The heat recuperation can stem from water cooling of the induction coils.

Further, a generator unit can supply energy to the pre-heating unit.

In addition, a control unit can be provided which controls the at least one flow meter and/or the pre-heating unit and/or at least one flow control valve. Further, a second opening can be provided in the enclosing member connecting the upper end of the interior of the enclosing member with the outside.

In addition, a meandering path in the form of a helicoidal channel can be provided as the space between the outer surface of the capsule wall and an inner wall of the enclosing member.

Further, the flow control valve can be provided in a liquid flow channel connecting the second opening and the pump unit.

In addition, wherein the temperature probe can be provided around the upper end of the helicoidal channel at the inner wall of the enclosing member.

According to a further aspect of the presently disclosed and/or claimed inventive concept(s), a method for producing a beverage is provided, wherein the method comprises the steps of providing a capsule containing ingredients, positioning the capsule in a beverage production machine and producing at least one opening in a wall of the capsule, wherein fluid under pressure is fed into capsule, wherein the fluid is heated by specific heating of the wall of capsule or/and a enclosing member for enclosing the capsule before the fluid under pressure enters the capsule by providing on a outer surface of the wall of the capsule metallic or/and electrically conducting areas and providing a means for contactlessly coupling of electrical heating to the metallic or/and electrically conducting areas of capsule at an enclosing member.

Further, the means for contactlessly coupling of electrical heating comprises induction coils.

Further advantages, features and objects of the presently disclosed and/or claimed inventive concept(s) will become evident for the man skilled in the art when reading the following detailed description of embodiments of the presently disclosed and/or claimed inventive concept(s).

Systems and methods for obtaining fluid comestibles from substances containing capsules are for example known from EP 512470 A1. The basic principle of this known system may be used also in combination with the presently disclosed and/or claimed inventive concept(s).

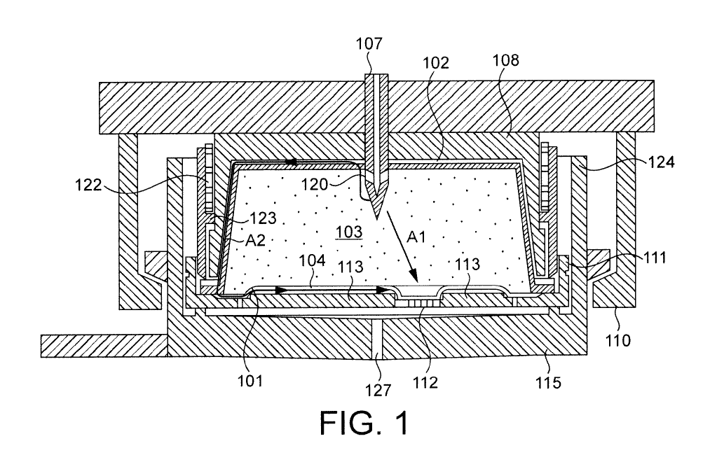

A capsule 101 as shown in FIG. 1 has a frustroconically-shaped cup body 102 which may be filled e.g. with a roasted and ground coffee 103 and which is closed by a foil-like tear face cover 104 welded and/or crimped to a flange-like rim which extends laterally from the side-wall of cup 102.

Other capsule designs, such as e.g. not hermetically sealed capsules may be used.

A capsule holder 111 comprises a flow grill 112 with relief surface element 113. The capsule holder 111 is accommodated in its support 115 which has a lateral wall 124 and a bore 127 for the passage of extracted coffee beverage. As can be seen from FIG. 1 the extraction system further comprises a water injector 107 having a water inlet channel 120 and an annular element 108 with an internal recess of which the shape substantially corresponds to the outer shape of the capsule. On its outer part, the annular member 108 comprises a spring 122 holding a ring 123 for releasing the capsule on completion of extraction. In operation, a capsule 101 is placed in the capsule holder 111. The water injector 107 perforates the upper face of cup 102. The lower tear face 104 of the capsule rests on the radially arranged members 113 of the capsule holder 111. The water is injected through channel 120 of the water injector 107 and impinges on bed 103 of coffee. The pressure in capsule 101 increases and the tear face 104 increasingly follows the shape of the radial opening relief members 113. Such radial opening relief members could be replaced by pyramid-shaped reliefs or other shapes of relief. When the constituent material of the tear face reaches its breaking stress, the tear face tears along the relief members. The extracted coffee flows through the orifices of the flow grill 112 and is recovered in a container (not shown) beneath the bore 127.

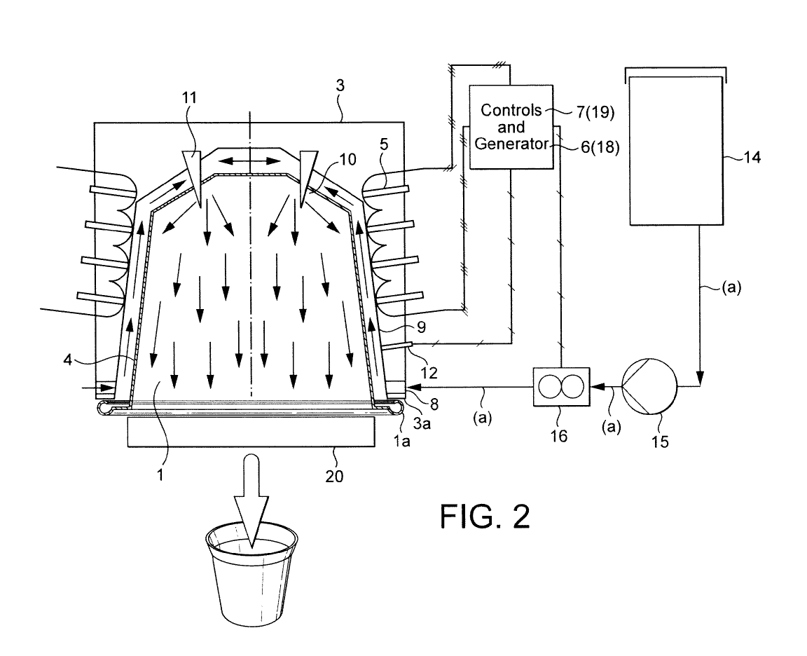

The basic principle of the capsule-based beverage production machine which may be applied according to the presently disclosed and/or claimed inventive concept(s) will now be explained with reference to FIG. 2. However, the presently disclosed and/or claimed inventive concept(s) is not limited to this principle.

FIG. 2 shows a beverage production system according to the first embodiment of the presently disclosed and/or claimed inventive concept(s). As one can see from the arrows (a), starting from a water tank 14 (which may be a part of the beverage production machine 2 or an external part), water or another liquid is supplied via a pump 15 and a flow meter 16 to the cavity defined by the bell-shaped enclosing member 3, which is designed to enclose a capsule 1 once inserted into the beverage production machine 2.

As it is shown in FIG. 2 the water is supplied into a space between the outer surface 4 of the capsule 1 and the inner wall 9 of the bell-shaped enclosing member 3, such as (but not limited to) through an opening 8 traversing the bell-shaped enclosing member 3 or through a gap (not shown) between a rim 3a of the bell-shaped enclosing member 3 and a flange-like rim 1a of the capsule 1.

The enclosing member 3 may be arranged to clamp the flange-like rim of the capsule against the capsule support.

Even if the rim of the enclosing member is arranged to form a gap with the rim of the capsule, in certain non-limiting embodiments, it will at least partially clamp the rim of the capsule.

The pressurized water will then be pushed along a path defined between the inner wall 9 of the bell-shaped enclosing member 3 and the outer surface 4 of a wall of the capsule 1, when the capsule 1 is placed, e.g. by a user on a capsule support 20.

The water will be in close contact with the outer surface 4 while being pushed along the path. The pressurized water can be heated along the path by conduction by contact with the metallic or/and electrically condutive areas of the outer surface 4 of the capsule wall and the inner wall 9 of enclosing member contactlessly heated by induction coils, which may serve as means 5 for generating a magnetic field for the induction heating process.

Other wireless heating power-transmission means may be used instead of the induction coils, such as e.g. an IR (Infrared) or microwave-based heating of the capsule walls and enclosing member walls.

Induction coils 5 are provided within the bell-shaped enclosing member 3 and can further have cores, in particular ferrite cores, to further strengthen the effect of induction.

In certain non-limiting embodiments, the induction coils are arranged in a distance of between 1 mm and 3 cm, such as (but not limited to) 3 mm and 2 cm, or 5 mm and 1.5 cm measured from the side wall of the capsule.

When the induction coils 5 are supplied with power the metallic or/and electrically conductive areas on the wall of the capsule 1 and enclosing member 3 walls are heated and accordingly the water in the space between outer surface 4 of the capsule 1 and the inner wall 9 of the bell-shaped enclosing member 3 is heated due to the heating of the metallic or/and electrically conductive areas on the wall of the capsule 1. Further, also liquid inside the capsule 1 can also be heated by contact with the capsule wall with the same induction process.

The electrically conductive areas can be made of aluminum or any other electrically conductive metal or non metal.

In certain non-limiting embodiments, the entire cup-shaped body of the capsule is made from an electrically conductive material or metal, such as aluminum, at least in portions of its outer surface (i.e. the surface facing the enclosing member).

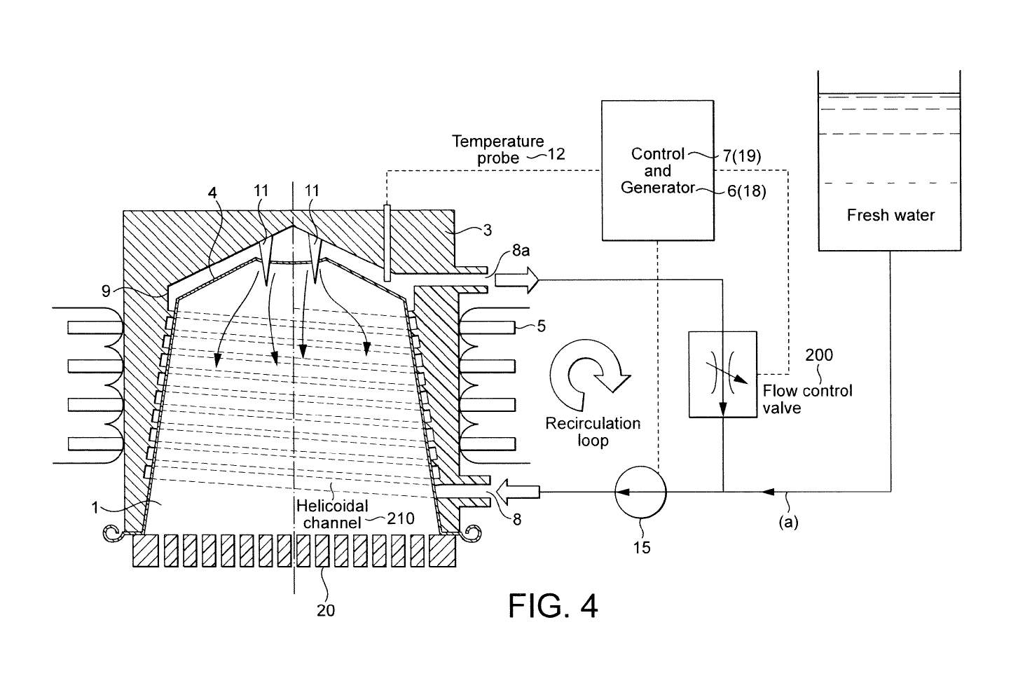

Meandering path defining means can be provided in order to promote any heat-exchange between the capsule wall and the water. In this way the water under pressure can be heated from, for example 12° C. at an opening 8 to, for example, a brewing temperature of 92° C. when entering the capsule. In this context a fluidic circuit can be designed to provide at least dual pressure levels with a recirculation feature. During the first heating phase, the liquid can be circulated with a low pressure and a high flow around the capsule 1. Once a target temperature is reached, a valve closes the circuit and will force the liquid through the capsule 1. This will guarantee that only hot liquid is forced through the interior of the capsule 1. A detailed description thereof will be given in the following with respect to FIG. 4.

The pressurized water will eventually arrive at the location where opening means 11 (blades, piercing means, . . . ) have already generated an inlet opening 10 in the upper wall of the capsule 1.

The opening means 11 may be operated to make a relative movement vis-à-vis bell-shaped enclosing member 3 or may act together with the enclosing member's closing movement (downwards in FIG. 2). The closing and/or the opening movement of bell-shaped enclosing member 3 may be manually operated or motor driven.

Alternatively the capsule is already provided with an inlet opening prior to its insertion into the machine, e.g. when manufacturing the capsule, in which case no opening means 11 are required.

After the heated water under pressure has entered the interior of the capsule 1 through the inlet opening, a beverage can be produced, wherein the water under pressure interacts with the ingredients in the capsule 1. The beverage can then flow to the rim area of enclosing member 3 and passes out of the capsule 1, thereby receiving a finished beverage. When the water flows from the inlet opening 10 to the rim area of the bell-shaped enclosing member 3 the water may be additionally further heated by the conductive areas provided at the outer surface 4 of the wall of the capsule 1, since the heat can also be conducted to the inner surface of the wall of the capsule 1, thereby a doubled heating is produced, i.e. a heating of the water under pressure outside the capsule 1 and a further heating inside the capsule 1.

The heating of the water under pressure can be significantly improved by providing ridges at the inner wall 9 of the enclosing member 3 projecting into the space between the outer surface 4 of the capsule wall and the inner wall 9 of the enclosing member 3 for creating a turbulent or prolonged (meandering) flow of the water. Due to the turbulent flow, a better mixing of the water and, therefore, a faster heating of the water under pressure in the space can be provided.

The capsule may be provided with means for reducing the heat exchange from the heated capsule wall to the ingredients contained in the capsule. These means may be means for thermally insolating the ingredients from the capsule wall and/or means for distancing the ingredients from the capsule wall.

In the following, the interaction of the components shown in FIG. 2 will be described in more detail. A control unit 7 of the beverage production machine 2 is arranged to control both the means 5 for contactlessly coupling heating power, a temperature probe 12 and a flow meter 16. However, also a separate control unit 19 can be provided for controlling a flow meter 16. Furthermore, a generator 6 is provided which can supply means 5 for contactlessly coupling heating power (in FIG. 2 induction coils) with energy. When the water flows through a pump 15 the water is impinged with pressure so that water under pressure arrives at a flow meter 16, which is able to measure the flow of water per time unit. These data can be sent to control unit 7, wherein the control unit 7 can subsequently control means 5 for contactlessly coupling heating power. After passing the flow meter 16 the water can enter opening 8 of the bell-shaped enclosing member 3.

Also a temperature probe 12, which can be provided at the inner wall of bell-shaped enclosing member 3, can send data to control unit 7 so that control unit 7 can adapt the power supply to specific needs, e.g. a nominal value for the water temperature.

The nominal value for the water temperature (in case of a feedback control of the temperature) or the transmitted heating power (in case of a feed-forward control) may be set adaptively, e.g. based on an identification of the capsule.

In case, a user of the beverage production system wants to have a specific temperature of the resulting beverage the control unit 7 can be arranged to control the power supply to the means 5 for wirelessly coupling electrical heating to control the heating of the outer surface 4 of the wall of the capsule 1, thereby controlling the heating of water under pressure within the space between the outer surface 4 of the capsule wall and inner wall 9 of the enclosing member 3.

With the arrangement as shown in FIG. 2 the induction coils can be controlled as needed in dependency of the data sent by the temperature probe 12 and the flow meter 16. For example, when for an optimal brewing process a temperature of the water under pressure at inlet opening 10 is 92° C. and a certain flux of water passing through the inlet opening 10 is needed to provide the optimal brew the control unit 7 can ensure this conditions by adapting the power supply to the induction coils 5 or the water amount passing through the inlet at the opening 7. However, it is also conceivable that a user of the beverage production system determines a certain brewing temperature so that the control unit 7 controls the water under pressure to provide a corresponding heating of the outer wall 4 of the capsule 1. In addition, the control unit 7 can also control a time dependent heating of the induction coils 5 so that the heating varies dependent on the elapsed time of the operation of the beverage production system. Also a specific heating of certain areas of the outer surface 5 of the wall of the capsule 1 is conceivable, so that, for example only a specific one of the induction coils 5 is activated wherein the other one is not supplied with energy. This can also be performed by the control unit 7. In this context it is mentioned that also liquid which is not under pressure can of course be heated by conduction if the liquid is in contact with a metallic or/and conductive part heated by induction.

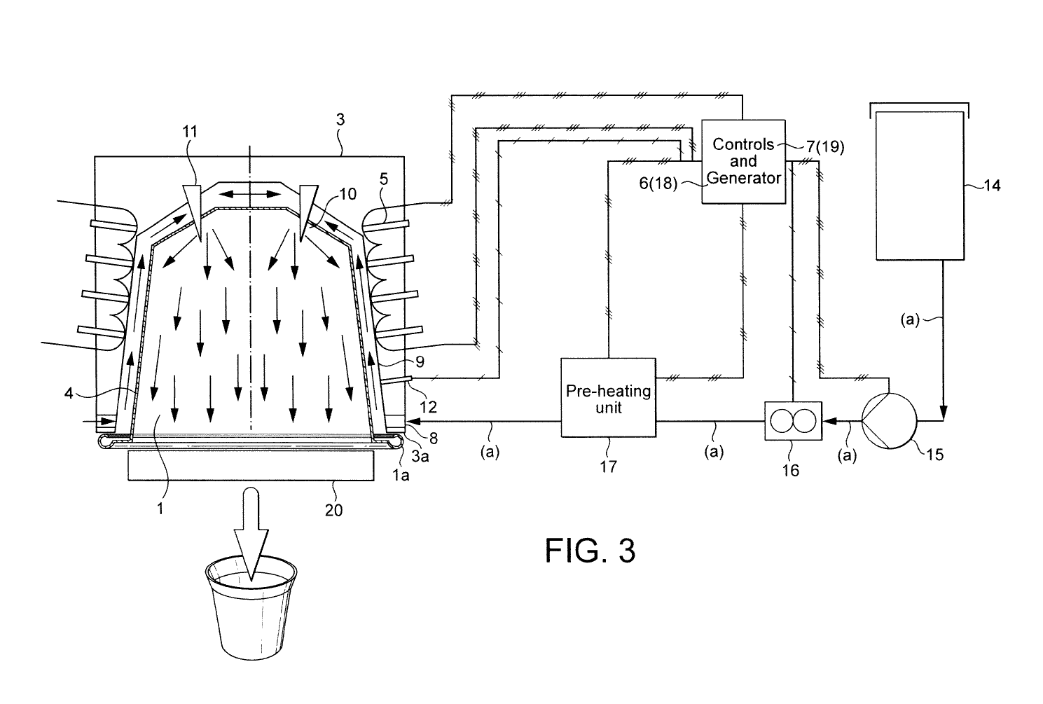

FIG. 3 shows a second embodiment of the presently disclosed and/or claimed inventive concept(s). In particular, there is provided an additional pre-heating unit 17 which preheats the water under pressure, from for example 12° C. to e.g. 55° C., before the water under pressure enters the gap 7. The pre-heating unit 17 is connected to a generator 18 and the control unit 19. Thereby, it is possible to control the pre-heating of the water under pressure. This can be done, for example, based on the temperature data supplied by the temperature probe 12. The second embodiment resembles a combination of a conventional heating of water under pressure together with heating of water under pressure by induction. The conventional part is represented by the pre-heating unit 17, wherein the induction heating is performed as described in FIG. 2. Since the remaining elements of FIG. 3 are the same as already described with respect to FIG. 2 a detailed description of these elements is omitted at this point.

FIG. 4 shows a third embodiment of the presently disclosed and/or claimed inventive concept(s). There, as indicated by arrows (a) fresh water is pumped via pump 15 into opening 8 of bell-shaped enclosing member 3. In addition, there is provided a fluidic circuit with at least dual pressure levels with a recirculation feature. In detail, the liquid enters opening 8 of bell-shaped enclosing member 3 and flows within a meandering path, which can be formed of a helicoidal channel 210 arranged between the outer surface 4 of the wall of the capsule 1 and the inner wall 9 of enclosing member 3, with a low pressure and leaves the bell-shaped enclosing member 3 through a second opening 8a. After passing opening 8a the liquid can flow through a flow control valve 200, which can be controlled by control unit 19, and can then flow again through pump 15 into opening 8. Accordingly, a recirculation loop can be provided, wherein the liquid is circulated with a low pressure and a high flow around the capsule 1. As described with respect to FIG. 2 the liquid is heated when flowing through helicoidal channel 210. Around the upper end of helicoidal channel 210 there can be provided temperature probe 12, which measures the temperature of the liquid exiting the helicoidal channel 210. Once the liquid has reached a target temperature measured by temperature probe 12 the flow control valve 200 closes the fluidic circuit. In closing flow control valve 200 the liquid is charged with a high pressure by pump unit 15 and the liquid is forced through openings 10 of capsule 1. This guarantees that only sufficiently hot liquid enters the interior of capsule 1 and lukewarm or cold liquid cannot come into contact with the ingredients of the capsule 1. Accordingly, only a brew with an excellent quality is provided.

The presently disclosed and/or claimed inventive concept(s) is not restricted to the above mentioned embodiments but can be improved and varied so as to comply with the desired needs. For example, the produced heat can also be localized at the gap 8 or only at the lower area of the outer surface 4 of the wall of the capsule 1. Further, fresh water can also be fed all along the whole wall of the capsule 1 and not just at the rim area of the enclosing member 3. Also water jets can be used impinging the capsule 1. Further, the space between the outer surface 4 of the capsule wall can be shaped in the form of channels.

### LIST OF REFERENCE NUMERALS:

(a) arrows
1 Capsule
1a flange-like rim
2 beverage production machine
3 bell-shaped enclosing member
3a rim of enclosing member
4 outer surface of a wall of the capsule
5 means for wirelessly coupling electrical heating power
6 generator unit
7 control unit for controlling means for wirelessly coupling electrical heating power
8 gap/opening
8a second opening
9 inner wall of enclosing member 3
10 inlet opening of capsule
11 opening means
12 temperature probe
13 ridges
14 liquid tank
15 pump unit
16 flow meter
17 pre-heating unit
18 generator
19 control unit for controlling flow meter and/or pre-heating unit
20 capsule support
200 flow control valve
210 helicoidal channel

1. A beverage production system, comprising:
a capsule designed for containing at least one beverage ingredient,
a beverage production machine designed for producing a beverage from the capsule's ingredients by having a liquid enter the capsule in order to interact with the ingredients in capsule,
wherein the beverage production machine comprises a bell-shaped enclosing member for enclosing the capsule, and wherein:
at least a portion of the outer surface of a wall of the capsule comprises at least one metallic and/or electrically conductive area, and
the beverage production machine comprises means for generating and for contactlessly coupling electrical heating power to the metallic and/or electrically conductive area of the capsule.

2. The beverage production system according to claim 1, wherein the beverage production machine comprises a generator unit generating power supplied to means for contactlessly coupling electrical heating power to the metallic and/or electrically conductive area of the capsule.

3. The beverage production system according to claim 1, wherein the means for contactlessly coupling electrical heating power comprise induction coils.

4. The beverage production system according to claim 1, wherein the metallic and/or electrically conductive areas at least partially consist of metal.

5. A beverage production system, comprising:
a capsule designed for containing at least one beverage ingredient,
a beverage production machine designed for producing a beverage from the capsule's ingredients by having a liquid under pressure enter the capsule in order to interact with the ingredients in the capsule,
wherein the beverage production machine comprises a bell shaped enclosing member for enclosing the capsule, characterized in that said beverage production machine is designed to have liquid under pressure enter a gap arranged in the rim area of bell-shaped enclosing member, such that the liquid under pressure enters a space between the outer surface of the capsule wall and an inner wall of enclosing member in order to enter the interior of capsule through at least one inlet opening in the wall of the capsule, which opening maybe pre-produced or produced by at least one opening means of beverage production machine.

6. The beverage production system according to claim 5, wherein at least one temperature probe is provided at inner wall of enclosing member to measure the temperature in the space between outer surface of the capsule wall and inner wall of the enclosing member.

7. The beverage production system according to claims 5, wherein ridges are provided at inner wall of the enclosing member projecting into the space between outer surface of the capsule wall and inner wall of the enclosing member for creating a turbulence flow of the fluid.

8. The beverage production system according to claim 1, wherein the liquid under pressure is supplied to the beverage production machine from a liquid tank.

9. The beverage production system according to claim 1, wherein at least one pump unit pumps the liquid under pressure to beverage production machine.

10. The beverage production system according to claim 1, wherein at least one flow meter is provided between liquid tank and beverage production machine.

11. The beverage production system according to claim 1, wherein a pre-heating unit preheats the liquid under pressure before being supplied to the capsule.

12. The beverage production system according to claim 11, wherein a generator unit supplies energy to pre-heating unit.

13. The beverage production system according to claim 10, wherein a control unit controls the at least one flow meter and/or pre-heating unit and/or at least one flow control valve.

14. The beverage production system according to claim 5, wherein a second opening is provided in enclosing member connecting the upper end of the interior of enclosing member with the outside.

15. The beverage production system according to claim 14, wherein a meandering path in the form of a helicoidal channel is provided as the space between the outer surface of the capsule wall and the inner wall of enclosing member.

16. The beverage production system according to claim 14, wherein the flow control valve is provided in a liquid flow channel connecting second opening and pump unit.

17. The beverage production system according to claim 14, wherein temperature probe is provided around the upper end of helicoidal channel at inner wall of enclosing member.

18. A method for producing a beverage, the method comprising the following steps:
providing a capsule containing ingredients,
positioning the capsule in a beverage production machine and producing at least one opening in a wall of the capsule, wherein fluid under pressure is fed into capsule, and
wherein the fluid is heated by specific heating of the wall of capsule and/or a enclosing member for enclosing the capsule before the fluid under pressure enters the capsule by providing on a outer surface of the wall of the capsule electrically conducting and/or metallic areas and providing a means for contactlessly coupling of a electrical heating to the electrically conducting and/or metallic areas of capsule at enclosing member.

19. The method according to claim 18, wherein means for contactlessly coupling of electrical heating comprise induction coils.
